(19) United States
(12) Patent Application Publication
(10) Pub. No.: US 2005/0222312 A1
(43) Pub. Date: Oct. 6, 2005

(54) Antioxidant and antimicrobial agents and methods of use thereof

(76) Inventors: John W. Frost, Okemos, MI (US); Gale M. Strasburg, East Lansing, MI (US)

Correspondence Address: HARNESS, DICKEY & PIERCE, P.L.C., P.O. BOX 828, BLOOMFIELD HILLS, MI, 48303, US

(21) Appl. No.: 11/125,679

(22) Filed: May 10, 2005

Related U.S. Application Data
(63) Continuation of application No. PCT/US03/36846, filed on Nov. 17, 2003.
(60) Provisional application No. 60/427,414, filed on Nov. 19, 2002.

(51) Int. Cl. C08K 5/13

(52) U.S. Cl. 524/342; 523/122

(57) ABSTRACT

A method of inhibiting microbial growth and of inhibiting oxidation of a target organic compound or food, medicine, or cosmetic is disclosed. The method comprises contacting the target organic compound or food with an effective amount of a phenolic compound comprising a single 6-carbon ring and from four to six hydroxyl groups, wherein an effective amount of the phenolic compound is an amount sufficient to inhibit oxidation of the target organic compound or food by at least 50% and sufficient to inhibit microbial growth in the presence of the target organic compound or food by at least 50%. The phenolic compound comprising a single 6-carbon ring and from four to six hydroxyl groups is preferably 1,2,3,4-tetrahydroxybenzene.

### CROSS REFERENCE TO RELATED APPLICATIONS

This is a continuation application of PCT/US2003/036846, filed Nov. 17, 2003, which claims priority to Provisional U.S. Ser. No. 60/427,414, filed Nov. 19, 2002, both of which are incorporated by reference herein.

### FIELD OF THE INVENTION

The present invention relates to the production of a polyhydroxybenzene comprising a single aromatic ring and from four to six hydroxyl moieties, in particular 1,2,3,4-tetrahydroxybenzene. The present invention further relates to the use of a polyhydroxybenzene comprising from four to six hydroxyl moieties, in particular 1,2,3,4-tetrahydroxybenzene, as both an antimicrobial agent and an antioxidant.

### BACKGROUND OF THE INVENTION

Antioxidants are molecules useful as preservatives of foods and of other molecules. Antioxidants used as food additives inhibit a food from decaying, becoming rancid, or discoloring by suppressing the reactions that occur when the food combines with oxygen in the presence of light, heat, or some metals. Antioxidants also reduce the damage to amino acids and vitamins that can occur when a food is stored, prepared, or cooked. Antioxidants commonly used in foods include butylated hydroxyanisole (BHA), butylated hydroxytoluene (BHT), tert-butylhydroquinone (TBHQ), and propyl gallate (PG). However, the safety of these molecules as food additives has been questioned. For example, BHA has been implicated as a carcinogen promoting formation of tumors in the forestomachs of rats (Nera, E. A., et al., Toxicology 32:197-213 (1984)). In addition, the synthesis or extraction of these compounds from natural sources can be tedious or expensive. For example, propyl gallate is synthesized by the esterification of gallic acid. Gallic acid is obtained by extraction from gall nuts, which are harvested by hand, a tedious and expensive process.

Each of the commonly used antioxidant compounds butylated hydroxyanisole (BHA), butylated hydroxytoluene (BHT), tert-butylhydroquinone (TBHQ), and propyl gallate (PG) is a phenolic compound comprising a single 6-carbon ring and from one to three hydroxyl moieties. While some antioxidant phenols of this structure also possess antimicrobial activity, the presence of antioxidant activity does not correlate with antimicrobial activity. In addition, the effectiveness of the antimicrobial activity of an antioxidant compound varies with the species or strain of microorganism as well as with environmental conditions (Fung, D. Y., et al., Crit. Rev. Microbio. 12:153-183 (1985).

In addition to the four antioxidant phenolic compounds BHA, BHT, TBHQ and PG, numerous other phenolic compounds comprising a single 6-carbon ring and from one to three hydroxyl moieties have been reported to exhibit antioxidant activity (Cuvelier, M.-E., et al., Biosci. Biotech. Biochem. 56: 324-325 (1992)). As a result of measurements of the antioxidant activities of phenolic compounds comprising one to three hydroxyl groups attached to an aromatic core, it was determined that all the monophenols were less efficient antioxidants than the polyphenols. However, Cuvelier et al. do not disclose the antioxidant activity of antimicrobial activity of any phenolic compound comprising a single 6-carbon ring and from four to six hydroxyl moieties, nor does it disclose anti-microbial activity of any phenolic compound.

Surprisingly, phenolic compounds comprising a single aromatic ring and from four to six hydroxyl moieties have not hitherto been considered for use as both an antioxidant and an antimicrobial agent. This lack of interest is possibly due to the known chemical instability of phenolic compounds comprising a single aromatic ring and five or six hydroxyl groups, and/or to the difficulty or expense of their synthesis.

U.S. patent application Ser. No. 09/937,243 to Frost et al. discloses a synthesis scheme for the phenolic compound 1,2,3,4-tetrahydroxybenzene. This method utilizes recombinant microbes to generate myo-2-inosose starting from a carbon source such as glucose. The myo-2-inosose is then converted to 1,2,3,4-tetrahydroxybenzene by acid catalyzed dehydration. However, this application does not contemplate the use of 1,2,3,4-tetrahydroxybenzene as an antioxidant or antimicrobial agent.

There thus remains a need for a polyhydroxybenzene compound which provides both antioxidant and antimicrobial activity, and exhibits sufficient chemical stability for use in production and storage of foods.

### SUMMARY OF THE INVENTION

The present inventors have developed methods for using a phenolic compound comprising four to six hydroxyl groups, in particular 1,2,3,4-tetrahydroxybenzene or a salt thereof, as both an antioxidant and as an antimicrobial agent. When used as an antioxidant and as an antimicrobial agent with a food, medicine, cosmetic, or organic compound, the phenolic compound of the invention acts as a preservative, reducing spoilage, decay, rancidity, and/or discoloration of the food product, a medicine, a cosmetic, or organic compound. The use of a phenolic compound of the invention as a preservative thereby increases the shelf life of a food, medicine, or cosmetic product. The phenolic compound is sufficiently chemically stable for its use as a preservative over an extended of time, preferably at least 48 hours, more preferably at least one month, more preferably at least six months, under standard storage conditions for foods, medicines, cosmetics, or organic compounds.

In one aspect, the invention is drawn to a method of inhibiting oxidation of a target organic compound and inhibiting microbial growth in the presence of the target organic compound, using a phenolic compound comprising a single 6-carbon ring and from four to six hydroxyl groups as an antioxidant and as an antimicrobial agent. In certain embodiments, the method comprises contacting a target organic compound with an effective amount of a phenolic compound having antioxidant and antimicrobial activity, wherein the phenolic compound comprises a single 6-carbon ring and from four to six hydroxyl groups from four to six hydroxyl moieties. The phenolic compound is preferably 1,2,3,4-tetrahydroxybenzene, or a salt thereof.

In certain embodiments, the invention provides a method for inhibiting oxidation of a food, a medicine, a cosmetic, or an organic compound, and simultaneously inhibiting microbial growth in the present of the food, medicine, or cosmetic. The method comprises contacting a food, a medicine, a cosmetic or an organic compound with an aromatic compound in an amount effective for providing antioxidant activity and antimicrobial activity. The aromatic compound comprises from four to six hydroxyl moieties, and is, preferably, 1,2,3,4-tetrahydroxybenzene or a salt thereof.

In certain preferred embodiments, the invention is drawn to a method of extending the shelf life of a food, a medicine, an organic compound, or a cosmetic. The method comprises contacting the food, medicine, cosmetic or organic compound with a hydroxybenzene comprising a single 6-carbon ring and from four to six hydroxyl groups, preferably 1,2,3,4-tetrahydroxybenzene or a salt thereof.

In certain preferred embodiments, the invention provides a method of killing a microbe or inhibiting growth of a microbe. In this method, a microbe is contacted with an effective amount of a antiseptic compound of the invention. The antiseptic compound comprises a single aromatic ring and four, five, or six hydroxyl moieties, and is preferably 1,2,3,4-tetrahydroxybenzene or a salt thereof.

Further areas of applicability of the present invention will become apparent from the detailed description provided hereinbelow. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates antioxidant activities of 1,2,3,4-tetrahydroxybenzene, propyl gallate, tert-butylhydroquinone, and α-tocopherol on corn oil stripped of endogenous antioxidants.

FIG. 2 illustrates antioxidant activities of 1,2,3,4-tetrahydroxybenzene, propyl gallate, tert-butylhydroquinone, and α-tocopherol on lard.

FIG. 3 illustrates the inhibitory activity of 1,2,3,4-tetrahydroxybenzene against growth of microbial species Salmonella typhimurium, Escherichia coli, and Listeria monocytogenes.

### DETAILED DESCRIPTION OF THE PREFERRED EMBODIMENTS

In one aspect, the invention provides a method of inhibiting oxidation of a target organic compound and inhibiting microbial growth in the presence of the target organic compound. The target organic compound can be any organic molecule which is subject to oxidation and/or subject to microbial growth in its presence, in non-limiting example, a pharmaceutical compound. The method comprises contacting the target organic compound with an effective amount of a phenolic compound comprising a single 6-carbon ring and from four to six hydroxyl groups. Preferably, the phenolic compound comprises a single 6-carbon ring and from four to six hydroxyl groups, more preferably 1,2,3,4-tetrahydroxybenzene or a salt thereof. The phenolic compound and the organic molecule can be dissolved in a solvent, or can be contacted in the absence of a solvent. The solvent can be an aqueous medium or an organic solvent. An effective amount, in this context, means an amount or the phenolic compound of the invention sufficient to inhibit oxidation by at least 50% when measured as the amount of formation of oxidation products of the target organic molecule in the absence of the phenolic compound of the invention, and also an amount sufficient to inhibit microbial growth in the presence of the target organic molecule by at least 50% when measured as the number of microbes growing in the presence of the target organic molecule, compared to growth in the absence of the phenolic compound of the invention. Preferably, an effective amount of the phenolic compound is from about 14 ppm (parts per million) to about 284,000 ppm, more preferably an effective amount of the phenolic compound is from about 1400 ppm to about 71,000 ppm. The target organic molecule protected from oxidation can be any naturally occurring or artificially synthesized target organic compound, for example a lipid, a protein, a peptide, an amino acid, a nucleic acid, a hormone, an alkaloid, a fluorophore, a chromophore, a pharmaceutical compound, an organic polymer, or a carbohydrate.

In another preferred embodiment, the invention is drawn to a method for inhibiting oxidation of a food, a medicine, or a cosmetic, and simultaneously inhibiting microbial growth in the present of the food, medicine, or cosmetic. The method comprises contacting the food, medicine or cosmetic with an effective amount of an aromatic compound comprising a single 6-carbon ring and from four to six hydroxyl groups. Preferably, the aromatic compound comprises a single 6-carbon ring and from four to six hydroxyl groups, more preferably 1,2,3,4-tetrahydroxybenzene. An “effective amount” in this context is an amount that inhibits oxidation of the food, medicine, or cosmetic by at least 50% compared to oxidation of the food, medicine, or cosmetic that is not contacted with the phenolic compound, as measured by the formation of oxidation products of the food, medicine, or cosmetic, and also inhibits microbial growth in the presence of the food, medicine, or cosmetic by at least 50% compared to the food, medicine, or cosmetic that is not contacted with the phenolic compound. Preferably, the phenolic compound is present at a concentration of from about 14 ppm to about 284,000 ppm, more preferably at a concentration from about 1400 ppm to about 71,000 ppm. Non-limiting examples of a “food” include edible matter such as a meat, a vegetable, a fruit, a cereal, a dairy product, a soft drink, an alcoholic beverage, a candy, a precursor to an edible matter (for example, an unprocessed grain), an edible oil, a prepared food, a canned food, a frozen food, an herb, a spice, flour, an animal fat, shortening, lard, sugar, a food additive (for example, a vitamin, a natural flavoring, an artificial flavoring, a sweetener, and a coloring), and chewing gum. Food can be raw or cooked. “Medicine” refers to a formulation provided for the treatment of disease or the improvement or maintenance of health or well-being in a human or animal. Non-limiting examples of a medicine include a prescription drug comprising a pharmaceutical compound, an “over-the-counter” medicine, an herbal medicine, a mouthwash, a toothpaste, and a deodorant. “Cosmetic” refers to a compound or mixture of compounds that is applied to a body to enhance personal attractiveness or alter personal appearance. Non-limiting examples of a cosmetic include a lipstick, a lip liner, a makeup, a body lotion, a hair dye, a nail polish, a mascara, an eye shadow, an eye liner, a foundation, a perfume, and a rouge.

In certain preferred embodiments, the invention is drawn to methods of extending the shelf life of a food, a medicine, or a cosmetic. The method of extending the shelf life comprises contacting the food, medicine with an effective amount of a hydroxybenzene comprising a single 6-carbon ring and four to six hydroxyl groups. Preferably, the hydroxybenzene is 1,2,3,4-tetrahydroxybenzene or a salt thereof. “Shelf life” refers to the time interval following production of a food, medicine or cosmetic and its consumption or use as an ingredient in the production of another food, medicine or cosmetic, during which time the food, medicine or cosmetic is considered sufficiently safe, organoleptically acceptable, nutritious, and/or effective for consumption as a food, medicine or cosmetic, or for use as an ingredient in other foods, medicines or cosmetics, and during which the food, medicine or cosmetic is stored under standard storage conditions. “Safe,” “nutritious” and “effective” as used herein refer to determinations of safety, nutritive value, or effectiveness according to industry or government standards, for example FDA standards for safety and effectiveness. “Organoleptically acceptable” means that a food, medicine or cosmetic is considered aesthetically acceptable to a majority of users. An “effective amount,” in this context, is an amount sufficient to extend the shelf life of the food or medicine by at least 48 hours, preferably by at least one month, more preferably by at least six months.

In certain preferred embodiments, the invention provides a method of killing a microbe or inhibiting growth of a microbe. In this method, a microbe is killed or growth-inhibited upon contact with an effective amount of an antiseptic compound comprising a sine aromatic ring and four, five or six hydroxyl groups, preferably 1,2,3,4-tetrahydroxybenzene, or a salt thereof. The microbe is a eukaryotic microbe or a prokaryotic microbe. The microbe can be, for example, a pathogenic microbe, a microbe that produces a toxin, in non-limiting example, an aflatoxin, or a microbe that despoils a food. An “effective amount” in this context means an amount sufficient to reduce microbial growth or presence by at least 50% compared to the microbial growth compared to the microbial growth or presence in the absence of the antiseptic compound. An effective amount of the antiseptic compound is preferably a concentration of from about 14 ppm to about 284,000 ppm, more preferably a concentration of from about 1400 ppm to about 71,000 ppm.

A prokaryotic microbe which is growth-inhibited or killed upon contact with an antiseptic compound of the invention, preferably 1,2,3,4-tetrahydroxybenzene or a salt thereof, includes both Gram-negative and Gram-positive bacterial species. Non-limiting examples of bacterial species against which the antiseptic compound of the invention, preferably 1,2,3,4-tetrahydroxybenzene or a salt thereof, acts as an antimicrobial agent include Agrobacterium tumefaciens, Bacillus cereus, Bacillus subtilis, Bacillus megaterium, Citrobacter freundii, Clostridium botulinum, Clostridium perfringens, Edwardsiella tarda, Enterobacter aerogenes, Enterobacter cloacae, Escherichia coli, Klebsiella oxytoca, Klebsiella pneumoniae, Lactobacillus brevis, Listeria monocytogenes, Pediococcus pentosaceus, Proteus vulgaris, Pseudomonas fluorescens, Pseudomonas fragi, Pseudomonas aeruginosa, Salmonella typhimurium, Salmonella enteritidis, Salmonella heidelberg, Salmonella senftenbert, Sarcina lutea, Serratia marcescens, Staphylococcus aureus, Streptococcus faecalis, Vibrio angularum, Vibrio parahaemolyticus, Vibrio parahaemolyticus, and Yersinia enterocolitica.

A eukaryotic microbe against which the antiseptic compound of the invention, preferably 1,2,3,4-tetrahydroxybenzene or a salt thereof, can act as an antimicrobial agent that inhibits growth or causes death following contact can be, as non-limiting examples, fungi and molds such as Aspergillus flavus, Aspergillus parasiticus, Aspergillus niger, Candida albicans, Candida parapsilosis, Geotrichum species, Penicillium expansum, Penicillium expansum, Saccharomyces cerevisiae, Schizosaccharomyces pombe and Torulopsis glabrata.

Examples illustrating methods of use of 1,2,3,4-tetrahydroxybenzene as an antioxidant and as an antimicrobial agent are described below.

### EXAMPLE 1

This example illustrates the use of 1,2,3,4-tetrahydroxybenzene as an antioxidant, and compares its activity as an antioxidant to some known antioxidants.

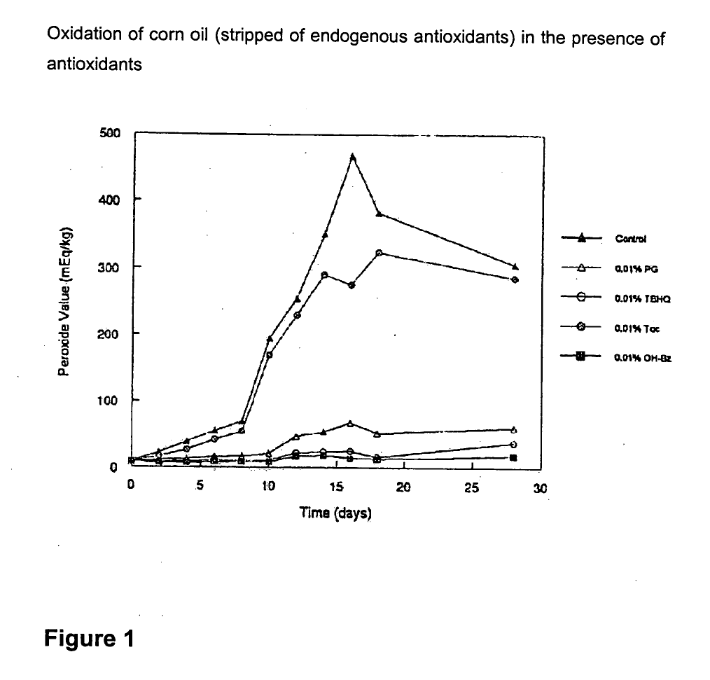

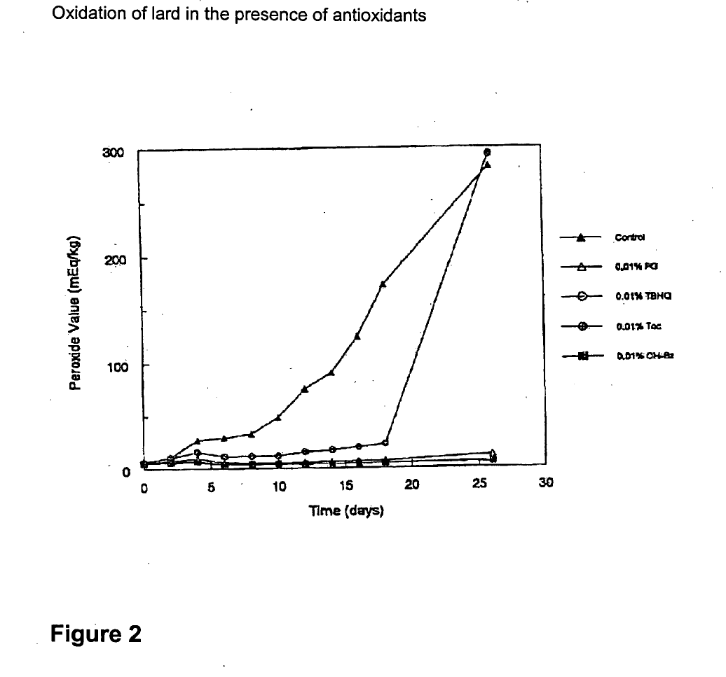

Aliquots of corn oil stripped of endogenous antioxidants were mixed with either 1,2,3,4-tetrahydroxybenzene (OH-Bz), or with a known antioxidant chosen from propyl gallate (PG), tert-butylhydroquinone (TBHQ), and α-tocopherol (Toc). Each antioxidant was at a concentration of 0.01% w/w (i.e., 100 ppm). The mixtures (as well as controls) were maintained at 60° C. Samples of each mixture were removed at a series of time points over a period of 28 days, and the peroxide value of each sample was measured using standard laboratory techniques (FIG. 1). Similarly, aliquots of lard were mixed with either 1,2,3,4-tetrahydroxybenzene (OH-Bz), or with a known antioxidant chosen from propyl gallate (PG), tert-butylhydroquinone (TBHQ), and α-tocopherol (Toc). Each antioxidant was at a concentration of 0.01% w/w. The mixtures (as well as controls) were maintained at 60° C. Samples of each mixture were removed at a series of time points over a period of 26 days, and the peroxide value of each sample was measured using standard laboratory techniques (FIG. 2). As shown in FIGS. 1 and 2, 1,2,3,4-tetrahydroxybenzene is a highly effective antioxidant, equal or superior to PG, TBHQ, PG, and α-tocopherol, and maintains its antioxidant activity for a period of at least 26 days.

### EXAMPLE 2

This example illustrates the use of 1,2,3,4-tetrahydroxybenzene as an antimicrobial agent, using inhibition zone experiments.

For these experiments, three strains of Listeria monocytogenes (CWD 95, CWD 246 and CWD 201), three strains of Escherichia coli O157:H7 (AR, AD 305, and AD 317), Salmonella typhimurium (clinical DT 104 isolate H3380), Salmonella enteritidis (clinical isolate H3527, phage type 13A) and Salmonella heidelberg (clinical isolate F5038BG1, Maryland outbreak) were obtained. All strains were stored at −70° C., in Trypticase soy broth containing 10% (v/v) glycerol. Thawed strains were subcultured three times in Trypticase soy broth containing 0.6% (w/v) yeast extract (TSB-YE) (Difco Laboratories, Detroit, Mich.) at 35° C., 18 to 24 h before use.

To test antimicrobial activity of 1,2,3,4-tetrahydroxybenzene, a pour plate technique was used in which 200 μl samples of subcultured bacteria (either 108 colony forming units (CFU)/ml of Salmonella, 109 CFU/ml of L. monocytogenes or 10⁹ CFU/ml of E. coli) were transferred to a Petri dish (100 mm×15 mm) to which 20 ml of Trypticase soy agar containing 0.6% (w/v) yeast extract (TSA-YE) was added. The contents of each Petri dish was then mixed by gently forming figure eights with the dish against the bench top. Separately, solutions of 1,2,3,4-tetrahydroxybenzene were prepared at the following concentrations: 1.4 M, 0.14 M, 0.014 M, 0.0014 M, and 0.00014 M. 16 mm filter discs comprising 1,2,3,4-tetrahydroxybenzene each then received 50 μl of a solution comprising one concentration of 1,2,3,4-tetrahydroxybenzene. A single 16 mm disc comprising 50 μl of one concentration of 1,2,3,4-tetrahydroxybenzene was then placed aseptically in the center of each Petri dish. The Petri dishes were then incubated at 35° C. Zones of growth inhibition were determined by observation at 24 hrs. All tests were run in triplicate and averaged.

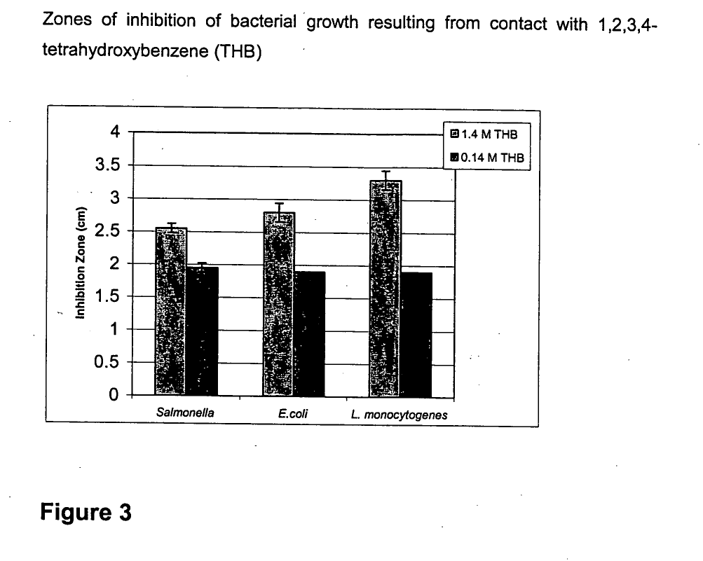

As shown in FIG. 3, filter disks to which 50 μl of 1,2,3,4-tetrahydroxybenzene at a concentration of 1.4 M or 0.14 M had been added led to appearance of zones of inhibition when applied to Petri dishes comprising bacteria. Concentrations of 1,2,3,4-tetrahydroxybenzene lower than 0.14 M did not form zones of inhibition greater than the diameter of the filter. The results demonstrate the antimicrobial activity of 1,2,3,4-tetrahydroxybenzene.

### EXAMPLE 3

This example illustrates the use of 1,2,3,4-tetrahydroxybenzene as an antimicrobial agent, using liquid culture assays.

For these experiments, sub-cultured bacteria (10⁸ cfu Salmonella; 10⁹ cfu Listeria monocytogenes and 10⁹ cfu E. coli) were each added to culture tubes containing TSB-YE. Three strains of each bacterial species were used, and 1,2,3,4-tetrahydroxybenzene was added to concentrations ranging from 1.4 mM to 14 mM. Three culture tubes were used for each 1,2,3,4-tetrahydroxybenzene concentration. The samples were incubated at 35° C. and observation of growth was recorded at 24 and 48 hrs. Results were reported as the number or tubes positive or negative for growth at 24 h and 48 h. For example: 3−/2+,1− indicates that there was no growth in all three tubes at 24 h, whereas at 48 h, there was growth in 2 tubes and no growth in one. Tables 1, 2, and 3 present results from growth inhibition tests on E. coli O157:H7, Salmonella species, and Listeria monocytogenes, respectively.

TABLE 1

| E. coli O157:H7 | Strain | | | |
|---|---|---|---|---|
| THB (M) | AD 305 | AD 317 | AR | cocktail |
| 0.0014 | 3+/3+ | 3+/3+ | 3+/3+ | 3+/3+ |
| 0.0028 | 3+/3+ | 3+/3+ | 3+/3+ | 3+/3+ |
| 0.0042 | 3+/3+ | 3+/3+ | 3−/3+ | 3+/3+ |
| 0.0056 | 3+/3+ | 3+/3+ | 3−/3− | 3−/3+ |
| 0.007 | 3−/3+ | 2+, 1−/2+, 1− | 3−/3− | 3−/1+, 2− |
| 0.0084 | 3−/2+, 1− | 3−/2+, 1− | 3−/3− | 3−/3− |
| 0.0098 | 3−/2+, 1− | 3−/3− | 3−/3− | 3−/3− |
| 0.0112 | 3−/3− | 3−/3− | 3−/3− | 3−/3− |
| 0.0126 | 3−/3− | 3−/3− | 3−/3− | 3−/3− |
| 0.014 | 3−/3− | 3−/3− | 3−/3− | 3−/3− |

TABLE 2

| Salmonella | Species | | | |
|---|---|---|---|---|
| THB (M) | typhimurium | enteritidis | heidelberg | cocktail |
| 0.0014 | 3+/3+ | 3+/3+ | 3+/3+ | 3+/3+ |
| 0.0028 | 3+/3+ | 3+/3+ | 3+/3+ | 3−/3+ |
| 0.0042 | 3+/3+ | 3+/3+ | 2+, 1−/3+ | 3−/3− |
| 0.0056 | 3−/2+, 1− | 3−/3− | 3−/3− | 3−/3− |
| 0.007 | 3−/3− | 3−/3− | 3−/3− | 3−/3− |
| 0.0084 | 3−/3− | 3−/3− | 3−/3− | 3−/3− |
| 0.0098 | 3−/3− | 3−/3− | 3−/3− | 3−/3− |
| 0.0112 | 3−/3− | 3−/3− | 3−/3− | 3−/3− |
| 0.0126 | 3−/3− | 3−/3− | 3−/3− | 3−/3− |
| 0.014 | 3−/3− | 3−/3− | 3−/3− | 3−/3− |

TABLE 3

| Listeria | | | | |
|---|---|---|---|---|
| monocytogenes | Strain | | | |
| THB (M) | 201 | 246 | 95 | cocktail |
| 0.0014 | 3+/3+ | 3+/3+ | 3+/3+ | 3+/3+ |
| 0.0028 | 3+/3+ | 3+/3+ | 3+/3+ | 3+/3+ |
| 0.0042 | 3−/3+ | 3+/3+ | 3−/3+ | 3+/3+ |
| 0.0056 | 3−/3− | 3−/3− | 3−/3− | 3−/3− |
| 0.007 | 3−/3− | 3−/3− | 3−/3− | 3−/3− |
| 0.0084 | 3−/3− | 3−/3− | 3−/3− | 3−/3− |
| 0.0098 | 3−/3− | 3−/3− | 3−/3− | 3−/3− |
| 0.0112 | 3−/3− | 3−/3− | 3−/3− | 3−/3− |
| 0.0126 | 3−/3− | 3−/3− | 3−/3− | 3−/3− |
| 0.014 | 3−/3− | 3−/3− | 3−/3− | 3−/3− |

Complete inhibition occurred at 1,2,3,4-tetrahydroxybenzene concentrations of 5.6 mM or greater for all strains tested. These data demonstrate that microbial growth is inhibited by contact with 1,2,3,4-tetrahydroxybenzene.

As various changes could be made in the above methods and compositions without departing from the scope of the invention, it is intended that all matter contained in the above description be interpreted as illustrative and not in a limiting sense.

All references cited in this specification are hereby incorporated by reference in their entirety. The discussion of the references herein is intended merely to summarize the assertions made by their authors and no admission is made that any reference constitutes prior art relevant to patentability. Applicant reserves the right to challenge the accuracy and pertinency of the cited references.

1. A method of inhibiting oxidation of a target organic compound and microbial growth in the presence of the target organic compound, the method comprising contacting the target organic compound with an effective amount of a phenolic compound comprising a single 6-carbon ring and from four to six hydroxyl groups, wherein an effective amount of the phenolic compound is an amount sufficient to inhibit oxidation of the target organic compound by at least 50% and sufficient to inhibit microbial growth by at least 50%.

2. A method according to claim 1, wherein the phenolic compound comprising a single 6-carbon ring and from four to six hydroxyl groups is 1,2,3,4-tetrahydroxybenzene or a salt thereof.

3. A method according to claim 2, wherein the effective amount of the phenolic compound is a concentration of from about 14 ppm to about 284,000 ppm.

4. A method according to claim 3, wherein the effective amount of the phenolic compound is a concentration of from about 1400 ppm to about 71,000 ppm.

5. A method according to claim 1, wherein the target organic compound is selected from the group consisting of a lipid, a protein, a peptide, an amino acid, a nucleic acid, a hormone, an alkaloid, a fluorophore, a chromophore, a pharmaceutical compound, an organic polymer, and a carbohydrate.

6. A method according to claim 5, wherein the target organic compound is a protein.

7. A method of inhibiting oxidation of a food, a medicine, or a cosmetic, and simultaneously inhibiting microbial growth in the presence of the food, the medicine, or the cosmetic, the method comprising contacting the food, the medicine or the cosmetic with an effective amount of an aromatic compound comprising a single 6-carbon ring and from four to six hydroxyl groups, wherein an effective amount of the aromatic compound is an amount sufficient to inhibit oxidation of the food, the medicine or the cosmetic by at least 50%, and inhibit microbial growth in the presence of the food, the medicine or the cosmetic by at least 50%.

8. A method according to claim 7, wherein the aromatic compound comprising a single 6-carbon ring and from four to six hydroxyl groups is 1,2,3,4-tetrahydroxybenzene or a salt thereof.

9. A method according to claim 8, wherein the effective amount of the aromatic compound is a concentration of from about 14 ppm to about 284,000 ppm.

10. A method according to claim 9, wherein the effective amount of the aromatic compound is a concentration of from about 1400 ppm to about 71,000 ppm.

11. A method of extending the shelf life of a food, a medicine, or a cosmetic, the method comprising contacting the food, the medicine, or the cosmetic with an effective amount of a hydroxybenzene comprising a single 6-carbon ring and from four to six hydroxyl groups.

12. A method according to claim 11, wherein the hydroxybenzene is 1,2,3,4-tetrahydroxybenzene or a salt thereof.

13. A method according to claim 12, wherein the effective amount of the hydroxybenzene is a concentration of from about 14 ppm to about 284,000 ppm.

14. A method according to claim 13, wherein the effective amount of the hydroxybenzene is a concentration of from about 1400 ppm to about 71,000 ppm.

15. A method according to claim 14, wherein the extending the shelf life is extending the shelf life by at least 48 hours.

16. A method according to claim 15, wherein extending the shelf life is extending the shelf life by at least six months.

17. A method of killing a microbe or inhibiting growth of a microbe, the method comprising contacting the microbe with an effective amount of an antiseptic compound comprising a single aromatic ring and four, five or six hydroxyl groups, wherein an effective amount of the antiseptic compound is an amount sufficient to inhibit microbial growth by at least 50%.

18. A method according to claim 17, wherein the antiseptic compound comprising a single aromatic ring and from four to six hydroxyl groups is 1,2,3,4-tetrahydroxybenzene or a salt thereof.

19. A method according to claim 18, wherein the effective amount of the antiseptic compound is a concentration of from about 14 ppm to about 284,000 ppm.

20. A method according to claim 19, wherein the effective amount of the antiseptic compound is a concentration of from about 1400 ppm to about 71,000 ppm.

21. A method according to claim 17, wherein the microbe is a prokaryotic microbe.

22. A method according to claim 21, wherein the prokaryotic microbe is a Gram-negative bacterium.

23. A method according to claim 21, wherein the prokaryotic microbe is a Gram-positive bacterium.

24. A method according to claim 17, wherein the microbe is a eukaryotic microbe.
